(19) United States
(12) Patent Application Publication
(10) Pub. No.: US 2013/0282793 A1
(43) Pub. Date: Oct. 24, 2013

(54) MEDIA CONTENT SHARING

(71) Applicants: Koen Swings, Hasselt (BE); Dirk Vangestel, Hasselt (BE)

(72) Inventors: Koen Swings, Hasselt (BE); Dirk Vangestel, Hasselt (BE)

(73) Assignee: ZAPPWARE NV, Hasselt (BE)

(21) Appl. No.: 13/821,076

(22) PCT Filed: Sep. 5, 2011
(86) PCT No.: PCT/EP11/65328

§ 371 Date: Mar. 6, 2013

(30) Foreign Application Priority Data
Sep. 8, 2010 (GB) 1014842.7

(51) Int. Cl. H04L 29/06

(52) U.S. Cl. CPC H04L 65/60
USPC 709/203

(57) ABSTRACT

The present invention generally relates to a system and methods for sharing multimedia contents in an intranet (for example, a private information network, including a home network or office network) including a plurality of clients, such as personal computers (PCs) or wired/wireless digital information appliances, such as for example televisions (TVs), Personal Digital Assistants (PDAs), Tablet PCs, Netbook PCs or the like; and include components and operations for receiving at a proxy server multimedia contents that are browsed and requested by a first client device via a communication network from a interactive service provides and for sharing said multimedia content by one or more client devices associated with the intranet.

### FIELD OF THE INVENTION

The present invention generally relates to a system and methods for sharing multimedia contents in an intranet (for example, a private information network, including a home network or office network) including a plurality of clients, such as personal computers (PCs) or wired/wireless digital information appliances, such as for example televisions (TVs), Personal Digital Assistants (PDAs), Tablet PCs, Netbook PCs, Smart Phones, or the like; and include components and operations for receiving at a proxy server multimedia contents that are browsed and requested by a first client device via a communication network from a interactive service provider and for sharing said multimedia content by one or more client devices associated with the intranet.

### BACKGROUND TO THE INVENTION

Recently, with the rapid development of computers and the enhanced capabilities of wired/wireless digital information appliances, such as for example televisions (TVs), Personal Digital Assistants (PDAs), Tablet PCs, Netbook PCs, Smart Phones, or the like; users have a myriad of capabilities to the internet for various documents and contents. In order to view a movie, listen to song, play a game, or download a multimedia file or digital object, a user will search for that content on the World Wide Web using a particular client device connected to the internet. The user may enjoy the content directly on the client device, but the user might really prefer to play the content found on the Internet on a home TV set, an MP3 player, in a car, on a personal video recorder, a PDA, or any of a myriad of devices.

For example, a user might find a movie on one web site, but desire playing it on a television that evening. The user might wish to download a song to a personal computer (PC), but also have it available in the car, on a portable MP3 player, and/or on a home MP3 enabled stereo system. In addition, a user might find a video news clip on a laptop using a web browser and wish to view it later on a cellular phone, or visa versa.

In a first effort to enable the above and to improve cross-talk between different multimedia customer devices, industry started the Digital Living Network Alliance (DLNA) in 2003, and published its DLNA interoperability guidelines and protocols in 2004 to enable DLNA certified products to work together. Through the implementation of DLNA protocols on the customer devices, said devices can connect, discover and communicate with each other over a home network. Depending on the capabilities and protocols present on said devices, devices will be recognized as Digital Media Server (DMS), Digital Media Player (DMP), Digital Media Renderer (DMR) and/or Digital Media Controller (DMR). Within a network of DLNA certified devices a user may have found and downloaded a song to his DLNA certified personal computer and is willing to play it on his DNLA certified Hi-Fi Stereo. As a DMP, the stereo can browse the digital content on the laptop (DMS) and play it. As a DMR, it can be controlled by the laptop now acting as a DMC and render the song. Evidently from the foregoing, in order to communicate with one another, each of said devices must be DLNA certified running one or more of the DLNA compatible protocols.

Another initiative to enable cross-communication between different client devices in a common network, consists the AirPlay protocol developed by Apple Inc. Analogous to DLNA, also in this instance and through the implementation of Airplay protocols on the customer devices, said devices can connect, discover and communicate with each other over a home network. Different from DLNA, with AirPlay there are only two categories of devices, either AirPlay Senders such as iPhones, iPods and iPads running the AirPlay sender protocol and Airplay Receivers, such as AV receivers, and stereo systems running the AirPlay receiver protocol, to render the content streamed over the local network by the AirPlay Sender. Thus again, in order to communicate with one another, each of said devices within the network must be running one or more of the AirPlay compatible protocols.

Thus it can be appreciated that a need in the art exists for a multi-media content distribution system, that allows a user to redirect content identified and rendered using a first client device (and optionally perform one or more additional operations thereon) to the appropriate device for use of the indentified content without the need of particular sender/controller and receiver/player/renderer protocols on each of said devices. Such a system would not be limited to videos or audio files, but would be similarly useful in the case of other files such as presentations, or even other applications such as computer games. Embodiments of the invention substantially fulfill these needs.

### SUMMARY OF THE INVENTION

In a first embodiment the present invention provides a multi-media content distribution system comprising an intranet including two or more client devices and a proxy server, wherein said proxy server is further connected with an interactive service provider, and characterized in that said proxy server comprises a multi-media content distribution protocol to relay any media item requested by a first client device to one or more other devices within a local network, without the first device being specifically adapted to relay the media content to said other devices. In a further aspect characterized in that the second, other device(s) do not have to run the complete interactive service.

It further provides the system as provided hereinbefore, wherein the multi-media content distribution protocol is capable of converting the multi-media content into a client-compatible format.

It further provides the system as provided hereinbefore, wherein the client devices comprise a media playback service.

It further provides the system as provided hereinbefore, wherein the interactive service provider is an interactive application server on the internet.

It further provides the system as provided hereinbefore, wherein the one or more client devices are selected from personal computers (PCs) or wired/wireless digital information appliances, such as for example televisions (TVs), Set Top Boxes (STB), Personal Digital Assistants (PDAs), Tablet PCs, Netbook PCs, Smart Phones, or the like.

In a particular embodiment, the other client device is a TV device or a Set Top Box connected thereto.

It further provides the system as provided hereinbefore, wherein the proxy server is a caching proxy server.

In a first preferred embodiment the multi-media content distribution protocol is residing on a proxy server to relay any media item of an interactive service, and requested by a first client device connected to said proxy server, to one or more other client devices connected to said proxy server; said protocol consisting of;
The user configures a client device (device1) to use a proxy server for all of its internet traffic;
The user starts and interacts with an interactive service on the Internet on device1, and starts a request to play or download a media item from the Internet;
The proxy server intercepts that request and forwards it to the Internet service;
The Internet service sends the requested media item as a response to the proxy server;
The proxy server caches the response and associates the response with device1;
The proxy server forwards the response to device1;
The user enjoys the media item on device1;
The user starts a media playback service on another device (eg a TV) (device2);
The media playback service requests the proxy for the names of all devices that have been used to play back media and for all the media items that have been played by these devices;
The proxy server sends the list of devices and media items to the media playback service on device2. The TV media playback service presents these lists to the user;
The user picks out a device (eg device1) and a media item (eg the last played media item). The media playback service requests the proxy service for this media item;
The proxy server locates the media item in its cache and sends the media item to the media playback service on device2;
The media playback service on device2 plays the media item and the user enjoys it on device2.

In a second preferred embodiment the multi-media content distribution protocol is residing on a proxy server to relay any media item of an interactive service, and requested by a first client device connected to said proxy server, to one or more other client devices connected to said proxy server; said protocol consisting of;
The user starts the media playback service on device2 and puts it into slave mode;
The user configures a client device (device1) to use a proxy server for all of its internet traffic;
The user starts and interacts with an interactive service on the Internet on device1, and starts a request to play or download a media item from the Internet;
The proxy server intercepts that request and forwards it to the Internet service;
The Internet service sends the requested media item as a response to the proxy server;
The proxy server caches the response and associates the response with device1;
The proxy server sends the response to the media playback service on device2;
The media playback service on device2 plays the media item and the user enjoys it.

In a further aspect the present invention provides Computer-readable media to perform the methods as described herein.

The computer-readable media typically being, selected from the group consisting of RAM, ROM, EEPROM, CD-ROM or other optical disk storage, magnetic disk storage or other magnetic storage devices, and any other medium that can be used to carry or store desired program code in the form of instructions or data structures and that can be accessed by a computer.

### BRIEF DESCRIPTION OF THE DRAWINGS

FIG. 1 illustrates an architecture diagram for the multi-media content distribution system in which the present invention resides.

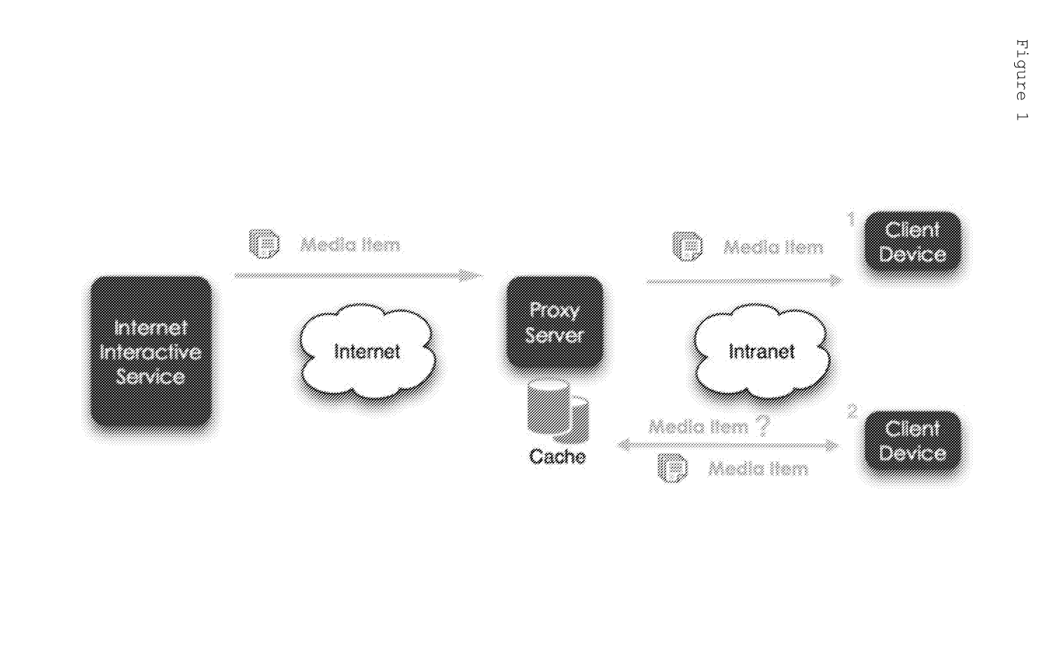

### DESCRIPTION OF THE INVENTION

The main principle of the invention is to use a proxy server, present as an intermediate between a client device and an interactive service on the Internet, to transparently relay any media item requested by a first client device to one or more other devices within a local network, without the first device being specifically adapted to redirect the media content to said other devices.

Accordingly, in a first aspect the present invention provides a multi-media content distribution system comprising an intranet including two or more client devices and a proxy server, wherein said proxy server is further connected with an interactive service provider, and characterized in that said proxy server comprises a multi-media content distribution protocol to relay any media item requested by a first client device and cached by the proxy server to one or more of the other client devices present in said intranet, without the first device being specifically adapted to allow for this relay.

In the present invention, an intranet includes networks, such as a home network or office network, having a server capable of performing Internet communications and a plurality of clients, and includes wired and wireless networks.

Within the context of the present invention said server not only operates as a proxy server, in that it acts as an intermediary for requests from clients seeking resources from other servers, more in particular servers providing multimedia interactive services, but also as a relay server to redirect content identified using a first client device, to one or more further client devices. When used as a normal proxy server, a client connects to the proxy server, requesting some service, such as a file, connection, web page, or other resource, available from a different server. The proxy server evaluates the request according to its filtering rules. For example, it may filter traffic by IP address or protocol. If the filter validates the request, the proxy provides the resource by connecting to the relevant server and requesting the service on behalf of the client. A proxy server may optionally alter the client's request or the server's response, and sometimes it may serve the request without contacting the specified server. In this case, it ‘caches’ responses from the remote server, and returns subsequent requests for the same content directly.

The application of such a caching proxy server accelerates service requests by retrieving content saved from a previous request made by the same client or even other clients in the local network. Caching proxies keep local copies of frequently requested resources, allowing users to significantly reduce their upstream bandwidth usage and cost, while significantly increasing performance, when a client device subsequently requests the same content from the remote server.

Notwithstanding the foregoing, one of the problems associated with the implementation of such a caching proxy server to share multi-media content amongst different client devices resides in the divergent capabilities of client devices in handling the large variety in multi-media content. Although wired/wireless digital information appliances include a processor that operates to execute computer code and produce and use data in conjunction with an operating system. Unlike personal computers, however, these devices typically use less complex operating systems as well as smaller and less expensive processors that are slower than the processors used in personal computers. While this may be appropriate when the devices operate normally, difficulties arise when these wired/wireless digital information appliances, like televisions (TVs) are used to connect to the proxy server and requests content saved from a previous request made by another client in the local network. The content present on the proxy server and retrieved based on a request from a first client device may be present in an incompatible format for another client in the network.

To address this problem, the proxy server of the present invention is further characterized in that it also acts as a relay server and comprises a multi-media content distribution protocol to transparently relay, i.e. without the first device being specifically adapted to allow for this relay and without the second device having to run the complete interactive service, any media item requested on a first client device to one more other devices within the network. In one aspect said multi-media content distribution protocol will convert the content into a client compatible format, enabling for example that the content of a website, identified by the first device, is rendered to a second device lacking a web browser.

The different steps in the protocol are detailed as follows:

1. The user configures a client device (device1) to use a proxy server for all of its internet traffic. Such configuration is a common feature on most devices that are built to consume Internet content

2. The user starts and interacts with an interactive service on the Internet on device1. As part of that interaction he starts a request to play or download a media item from the Internet.

3. The proxy server intercepts that request and forwards it to the Internet service.

4. The Internet service sends the requested media item as a response to the proxy server.

5. The proxy server caches the response and associates the response with device1

6. The proxy server forwards the response to device1

7. The user enjoys the media item on device1

8. The user starts a media playback service on another device (eg a TV) (device2)

9. The media playback service requests the proxy for the names of all devices that have been used to play back media and for all the media items that have been played by these devices.

10. The proxy server sends the list of devices and media items to the media playback service on device2. The TV media playback service presents these lists to the user.

11. The user picks out a device (eg device1) and a media item (eg the last played media item). The media playback service requests the proxy service for this media item.

12. The proxy server locates the media item in its cache and sends the media item to the media playback service on device2.

13. The media playback service on device2 plays the media item and the user enjoys it on device2.

In an alternative embodiment of the present invention the media playback service on the second device is put into slave mode. In this model of communication one device or process (the master) has unidirectional control over one or more other devices (the slaves). In the present case, the proxy server initiates and controls the transmission of any media item and accordingly operates as the master. The media playback service on the second device, i.e. the slave will respond to commands from the master and display any media content send from the proxy server on said device.

In this alternative embodiment the different steps in the protocol are detailed as follows:

1. The user starts the media playback service on device2 and puts it into slave mode. In slave mode, the media playback service is listening to any media item that is send from the proxy server.

2. The user configures a client device (device1) to use a proxy server for all of its internet traffic. Such configuration is a common feature on most devices that are built to consume Internet content

3. The user starts and interacts with an interactive service on the Internet on device1. As part of that interaction he starts a request to play or download a media item from the Internet.

4. The proxy server intercepts that request and forwards it to the Internet service.

5. The Internet service sends the requested media item as a response to the proxy server.

6. The proxy server caches the response and associates the response with device1

7. The proxy server sends the response to the media playback service on device2

8. The media playback service on device2 plays the media item and the user enjoys it.

In a particular embodiment of the present invention, the system(s) and protocol(s) is(are) optimized to make interactive service(s) on the Internet available on a TV device. It is accordingly an object of the present invention to provide the use of a proxy server as an intermediate between a client device and an interactive service on the Internet, and to use said proxy server to transparently relay any media item requested on the client device to one or more TV devices, without the client device being specifically adapted to redirect the media content to said one or more TV devices.

The various illustrative logics, logical blocks, modules, devices, and circuits, including personal computers, set top boxes, media playback devices, and servers, described in connection with the implementations disclosed herein may be implemented or performed with or using a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In one or more exemplary implementations, the functions described may be implemented in hardware, software, firmware, or any combination thereof. If implemented in software, the functions may be stored on or transmitted over as one or more instructions or code on a computer-readable medium.

Accordingly, in an even further aspect the present invention provides computer-readable media to perform the multi-media content distribution protocol of the present invention. The Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. The steps of a method or algorithm described in connection with the implementations disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium is coupled to the processor, such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

1. A multi-media content distribution protocol residing on a proxy server to relay any media item of an interactive service, and requested by a first client device connected to said proxy server, to one or more other client devices connected to said proxy server; wherein the protocol allows said distribution without the first device being specifically adapted to allow for this relay and without the one or more other devices having to run the complete interactive service.

2. The protocol according to claim 1, wherein said protocol is configured to convert the multi-media content into a client-compatible format.

3. The protocol according to claim 1, wherein the one or more client devices are selected from personal computers (PCs), wired/wireless digital information appliances, televisions (TVs), Set Top Boxes (STB), Personal Digital Assistants (PDAs), Tablet PCs, Netbook PCs, and Smart Phones.

4. The protocol according to claim 1, wherein the one or more client devices is a TV device or Set Top Boxes connected thereto.

5. The protocol according to claim 1, wherein the proxy server is a caching proxy server.

6. The protocol according to claim 1, wherein the one or more other client device comprise a media playback service.

7. The protocol according to claim 6, wherein the media playback service operates in slave mode.

8. A method of operating a multi-media content distribution protocol residing on a proxy server to relay any media item of an interactive service, and requested by a first client device connected to said proxy server, to one or more other client devices connected to said proxy server; said method consisting of:
a. Configuring the client device to use the proxy server for all of its internet traffic;
b. Interacting with the interactive service on the Internet on the first client device, and starting a request to play or download a requested media item from the Internet;
c. Intercepting, via the proxy server, the request and forwarding the request to the Internet service;
d. Sending, via the Internet service, the requested media item as a response to the proxy server;
e. Caching, via the proxy server, the response and associating the response with the first client device;
f. Forwarding, via the proxy server, the response to the first client device;
g. Playing the media item on the first client device;
h. Starting a media playback service on a second device;
i. Requesting, via the media playback service, the proxy for names of all devices that have been used to play back media and for all the media items that have been played by said devices;
j. Sending, via the proxy server, a list of the devices and the media items to the media playback service on the second device; wherein the TV media playback service presents these lists to the user;
k. Selecting a media item on the second device; wherein the media playback service requests the proxy service for the selected media item;
I. Locating, via the proxy server, the media item in its cache and sending the selected media item to the media playback service on the second device; and
m. Playing, via the media playback service on the second device, the selected media item.

9. A method of operating a multi-media content distribution protocol residing on a proxy server to relay any media item of an interactive service, and requested by a first client device connected to said proxy server, to one or more other client devices connected to said proxy server; said method consisting of:
a. Starting the media playback service on the one or more other client devices and putting it into slave mode;
b. Configuring a first client device to use a proxy server for all of its internet traffic;
c. Starting and interacting with an interactive service on the Internet on the first client device, and starting a request to play or download a requested media item from the Internet;
d. Intercepting, via the proxy server the request and forwarding the request to the Internet service;
e. Sending, via the Internet service, the requested media item as a response to the proxy server;
f. Caching, via the proxy server, the response and associating the response with the first client device;
g. Sending, via the proxy server, the response to the media playback service on the one or more client devices; and
h. Playing, via the media playback service, on the one or more client devices the requested media item.

10. A non-transitory computer-readable media which provides instructions that causes a proxy server, a first client device, and one or more other client devices to perform the method as defined in claim 8.

11. The non-transitory computer-readable media according to claim 10, selected from the group consisting of RAM, ROM, EEPROM, CD-ROM, optical disk storage, magnetic disk storage or magnetic storage devices.
